(19) United States
(12) Patent Application Publication
(10) Pub. No.: US 2005/0284689 A1
(43) Pub. Date: Dec. 29, 2005

(54) Clockspring with sound dampener

(76) Inventors: Michael Simpson, Macomb, IL (US); Pat Bolen, Carthage, IL (US); Christopher Wyatt, Hamilton, IL (US); Brent Henderson, Ursa, IL (US)

Correspondence Address: BLANK ROME LLP, 600 NEW HAMPSHIRE AVENUE, N.W., WASHINGTON, DC, 20037, US

(21) Appl. No.: 10/873,516

(22) Filed: Jun. 23, 2004

(51) Int. Cl. F16F 15/00; E04B 1/82; E04B 2/02

(52) U.S. Cl. 181/209; 181/290

(57) ABSTRACT

A sound dampener including a first layer that has first and second opposite surfaces. The first layer is substantially ring-shaped with a first central aperture with a first perimeter. A second layer is disposed on one of the first and second opposite surfaces of the first layer. The second layer is substantially ring-shaped with a second central aperture with a second perimeter. The second perimeter defines a circumference that is smaller than a circumference of the first perimeter of the first central aperture so that an extended portion of the second layer extends beyond the first perimeter of the first central aperture of the first layer.

### FIELD OF THE INVENTION

The present invention generally relates to a clockspring for a vehicle steering wheel that includes a sound dampener. More specifically, the sound dampener significantly reduces noise created both by friction between the clockspring and its flat cable and by vibration of the clockspring.

### BACKGROUND OF THE INVENTION

Clocksprings are typically provided in a vehicle steering wheel to supply electrical power via a flat cable to certain components, such as an air bag. Conventional clocksprings produce noise typically caused by the movement and vibration of the flat cable within the clockspring housing. In particular, as the flat cable winds and unwinds within the clockspring housing, friction between the flat cable and the housing wall surfaces creates noise. Additionally, vibration of the clockspring, particularly when the vehicle is idling, creates additional noise due to movement of the flat cable and collisions with the clockspring housing walls.

Some conventional clocksprings employ a noise absorbing structure which often fail to effectively absorb noise and/or fail to absorb the noise caused by both friction between the flat cable and the clockspring housing and vibration of the clockspring.

Examples of conventional clocksprings with sound absorbing structure includes U.S. Pat. No. 6,457,549 to Sugata; U.S. Pat. No. 6,196,488 to Sakata et al.; and U.S. Pat. No. 6,019,621 to Sugata et al., the subject matter of each of which is herein incorporated by reference.

### SUMMARY OF THE INVENTION

Accordingly, an object of the present invention is to provide a clockspring with a sound dampener that effectively absorbs noise caused by both friction between the flat cable and clockspring housing and vibration of the clockspring.

The foregoing object is attained in accordance with the present invention by a sound dampener including a first layer that has first and second opposite surfaces. The first layer is substantially ring-shaped with a first central aperture with a first perimeter. A second layer is disposed on one of the first and second opposite surfaces of the first layer. The second layer is substantially ring-shaped with a second central aperture with a second perimeter. The second perimeter defines a circumference that is smaller than a circumference of the first perimeter of the first central aperture so that an extended portion of the second layer extends beyond the first perimeter of the first central aperture of the first layer.

The foregoing objects are also attained in accordance with the invention by a clockspring including a stationary member that has a first bearing surface and a movable member rotatably engaged with the stationary member. The movable member has a second bearing surface. A cable retaining compartment is defined between the stationary and movable members. A flat cable is disposed in the cable retaining compartment, and having opposite first and second ends and opposite first and second side edges. A sound dampener is disposed between either one of the first bearing surface of the stationary member and the first side edge of the flat cable and the second bearing surface of the movable member and the second side edge of the flat cable so that there is substantially no space between the first bearing surface and the first side edge and between the second bearing surface and the second side edge. The sound dampener has a first foam layer with a second smooth layer disposed on the first foam layer.

The foregoing objects are also attained in accordance with the invention by a clockspring including a stationary member having a first bearing surface and a movable member rotatably engaged with the stationary member. The movable member has a second bearing surface. A cable retaining compartment is defined between the stationary and movable members. A flat cable is disposed in the cable retaining compartment, and has opposite first and second ends and opposite first and second side edges. A sound dampener is disposed between either of the first bearing surface of the stationary member and the first side edge of the flat cable and the second bearing surface of the movable member and the second side edge of the flat cable, and the sound dampener has a first layer with a first central aperture defining a perimeter with a second layer disposed on the first layer and including an extended portion extending beyond the perimeter of the first layer.

Other objects, advantages and salient features of the invention will become apparent from the following detailed description, which, taken in conjunction with the annexed drawings, discloses preferred embodiments of the present invention

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of a clockspring in accordance with the present invention;

FIG. 2 is a plan view of a sound dampener and a moveable member of the clockspring illustrated in FIG. 1, showing the sound dampener disposed in the moveable member;

FIG. 3 is a side elevational view in section of the clockspring illustrated in FIG. 1, showing the clockspring assembled with the sound dampener disposed in the moveable member of the clockspring;

FIG. 4 is a side elevational view in section of the clockspring similar to FIG. 3, showing the sound dampener on a stationary member of the clockspring;

FIG. 5 is a plan view of the sound dampener in accordance with a first embodiment of the present invention;

FIG. 6 is a partial side elevational view taken in section along line 6-6 of FIG. 5;

FIG. 7 is a plan view of a sound dampener in accordance with a second embodiment of the present invention;

FIG. 8 is a plan view of a sound dampener in accordance with a third embodiment of the present invention;

FIG. 9 is a partial side elevational view in section of a sound dampener in accordance with a fourth embodiment of the present invention; and

FIG. 10 is a plan view of a sound dampener in accordance with a fifth embodiment of the present invention.

### DETAILED DESCRIPTION OF THE INVENTION

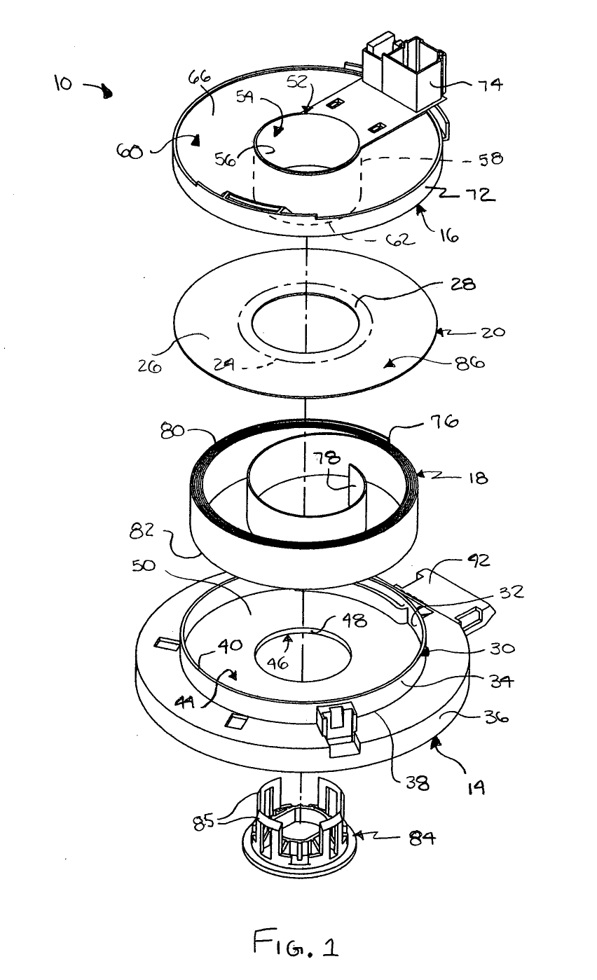

Referring to FIGS. 1-6, a clockspring 10 in accordance with the present invention generally includes a stationary member 14 fixed to a steering wheel column (not shown) and a moveable member 16 which rotates along with the steering wheel, as is well known in the art. A flat cable 18 is wound between stationary and moveable members 14 and 16 for electrically connecting equipment installed on the steering wheel, such as an air bag, to the electronics of the vehicle. A sound dampener 20 is disposed in a cable cavity 22 defined between the stationary member 14 and the moveable member 16.

Sound dampener 20 reduces noises caused by the frictional engagement of the flat cable 18 with either the stationary or moveable members 14 and 16 and the impact of the flat cable 18 with either member 14 and 16 during vibration of the clockspring 10, such as when the vehicle is idling. Sound dampener 20 substantially eliminates all space between the flat cable 18 and members 14 and 16 via a first thick layer 24 to substantially reduce vibrational noises and provides a smooth continuous surface via a second layer 26 to substantially prevent frictional noises. Additionally, an extended or overhang portion 28 can be included with the sound dampener 20 to provide a continuous smooth surface for engaging the flat cable 18.

As seen in FIGS. 1, 3 and 4, stationary member 14 includes a substantially cylindrical wall 30 with inner and outer surfaces 32 and 34. Preferably, wall 30 is substantially rigid and formed of a plastic material. A shoulder 36 extends from outer surface 32 at one edge 38 of wall 30 with the opposite edge of wall 30 being a free edge 40. A connector unit 42 extends from shoulder 36 for connection with an electrical cable (not shown).

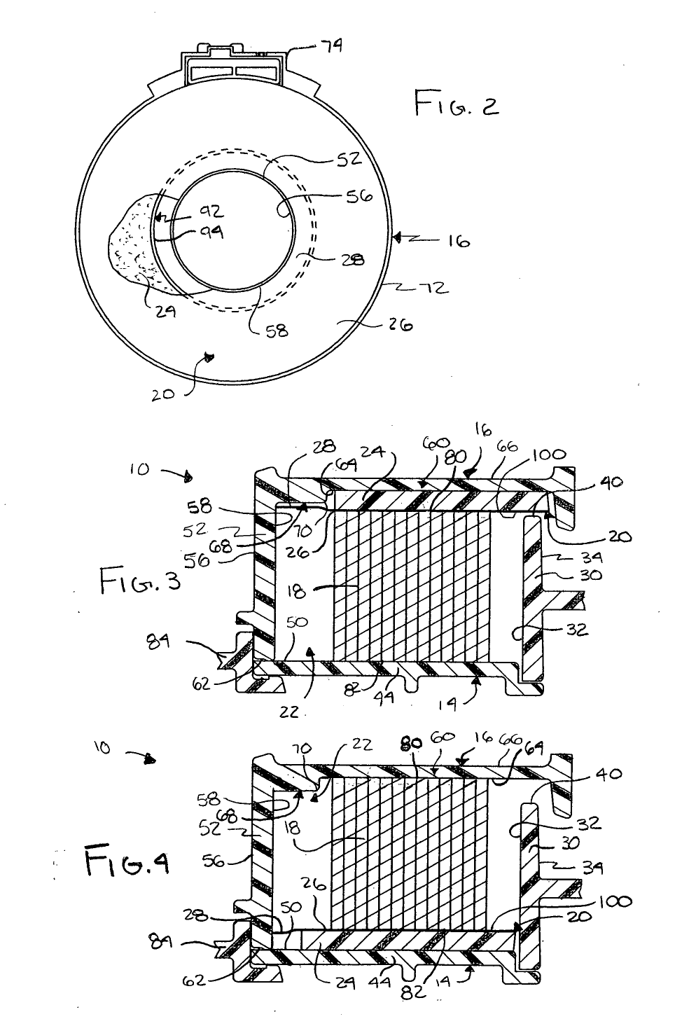

A circular disk 44 is disposed within wall 30 at the edge 38 opposite free edge 40 and attached to wall 30 by any known attachment method. Circular disk 44 includes a central aperture 46 defining a central perimeter 48. Circular disk 44 includes inner bearing surface 50. As seen in FIG. 3, inner bearing surface 50 defines a portion of the cable cavity 22 supporting flat cable 18.

As seen in FIGS. 1-4, moveable member 16 includes a substantially cylindrical wall 52 shaped as a hub defining a central axis about which moveable member 16 rotates. Cylindrical wall 52 defines an inner passageway 54. Like wall 30 of stationary member 14, wall 52 of moveable member 16 is preferably substantially rigid. Wall 52 of moveable member 16 includes inner and outer surfaces 56 and 58.

A circular disk 60 extends from outer surface 56 of wall 52. A free edge 62 of wall 52 abuts circular disk 44 of stationary member 14 and is aligned with central aperture 46 thereof. Circular disk 60 includes an inner bearing surface 64 and an opposite outer surface 66. Like bearing surface 50 of stationary member 14, bearing surface 64 forms a portion of cable cavity 22. Circular disk 60 also includes a ledge 68 surrounding cylindrical wall 52 along the periphery of moveable member 16 that has a transition shoulder 70. An outer secondary wall 72 extends around the outer perimeter of circular disk 60. As seen in FIG. 2, a connector unit 74 extends from secondary wall 72 for connection with an electrical cable (not shown).

Flat cable 18 includes opposite first and second ends 76 and 78. First end 76 of flat cable 18 is connected to connector unit 42 of stationary member 14. Second end 78 is connected to connector unit 74 of moveable member 16. As seen in FIGS. 3 and 4, flat cable 18 includes opposite first and second side edges 80 and 82.

As seen in FIGS. 1, 3 and 4, a clip 84 extends through central aperture 46 of wall 30 of stationary member 14 and into inner passageway 54 of wall 52 of moveable member 16 to couple stationary and moveable members 14 and 16. Clip 84 includes one or more latch arms 85 which enter inner passageway 54 of wall 52 and engage detents (not shown) to lock members 14 and 16 together.

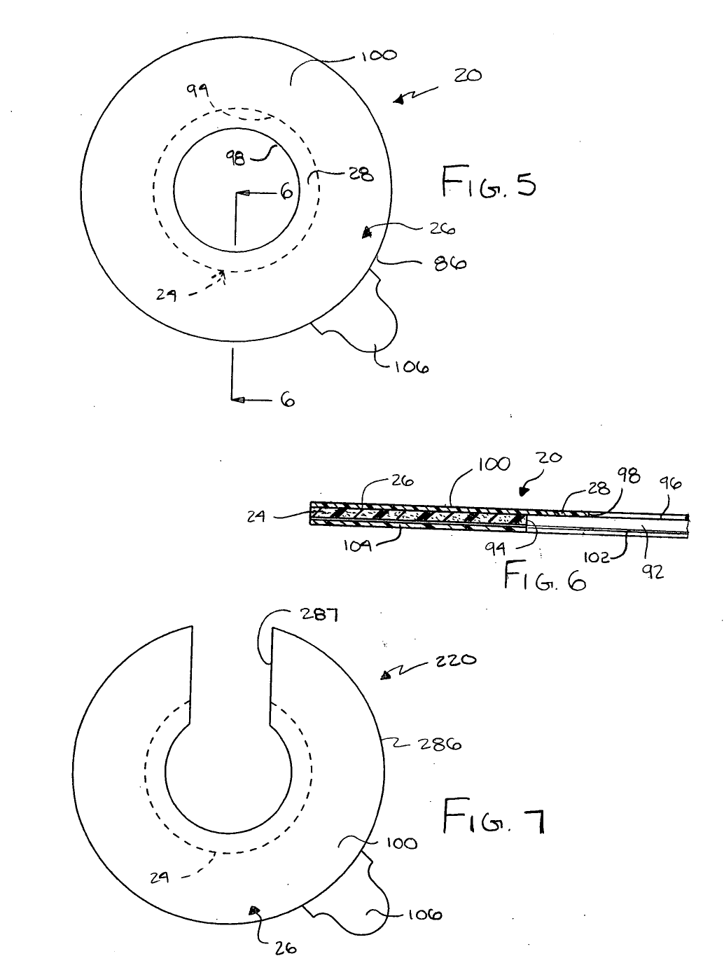

As seen in FIGS. 5 and 6, sound dampener 20 has a continuous ring-shaped body 86 including first and second layers 24 and 26. First and second layers 24 and 26 can be laminated together by adhesive or other known bonding methods. First layer 24 includes a first aperture 92 with a first perimeter 94. Second layer 26 includes a second aperture 96 with a second perimeter 98. The second perimeter 98 has a circumference that is smaller than the circumference of the first perimeter 94, thereby defining extended portion 28 of the second layer 26, as best seen in FIG. 6.

First layer 24 is substantially thicker than second layer 26. First layer 24 is preferably formed of a resilient material, such as foam, including open cell and closed cell foam, microporous plastic, polystyrene, and the like, to fill the space or gaps between the sides edges 80 and 82 of flat cable 18 and the bearing surfaces 50 and 64 of stationary and moveable members 14 and 16, respectively and provide a cushioning effect. Second layer 26 is preferably formed of a smooth or slidable material, such as polyethylene, thermoplastic resin, polyester, and the like, thereby defining a smooth engagement surface 100 for engaging the side edges 80 and 82 of flat cable 18.

An adhesive layer 102 can be applied to first layer 24 opposite second layer 26, as seen in FIG. 6, to secure sound dampener 20 to either bearing surface 50 and 64 within cable cavity 22. A release liner 104 can be provided to cover adhesive layer 102. A tab 106 can also be included with release liner 104, as seen in FIG. 5, to assist in removal of release liner 104 from adhesive layer 102 when ready to apply sound damper 20 to either member 14 and 16. However, adhesive layer 102 is not required, as seen in FIGS. 3 and 4, such that sound dampener 20 is not fixed to either bearing surface 50 and 64 within the cable cavity 22.

When clockspring 10 is assembled, wall 52 of moveable member 16 is disposed within wall 30 of stationary member 14. Flat cable 18 is received in cable cavity 22 defined between walls 30 and 52 and bearing surfaces 50 and 64 of stationary and moveable members 14 and 16, respectively. Free edge 40 of stationary wall 30 is disposed near circular disk 60 of moveable member 16. Free edge 62 of moveable wall 52 abuts circular disk 44 of stationary member 14 with inner passageway 54 of moveable member 16 and central aperture 46 of circular disk 44 being aligned. Clip 84 extends through central aperture 46 of wall 30 and into inner passageway 54 of wall 52 to couple stationary and moveable members 14 and 16. In operation, flat cable 18 winds and unwinds within cable cavity 22 as the steering wheel is turned.

Sound dampener 20 is disposed within cable cavity 22 and can be applied to bearing surface 64 of moveable member 16, as seen in FIG. 3, or to bearing surface 50 of stationary member 14, as seen in FIG. 4. When placed on bearing surface 64, first layer 24 rests on bearing surface 64. Alternatively, first layer 24 can be fixed to bearing surface 64 via adhesive layer 102 (FIG. 6). Second layer 26 extends to wall 52 of moveable member 16. Extended portion 28 of second layer 26 extends over the ledge 68 of moveable member 16 providing a continuous smooth engagement surface 100 all the way to outer surface 58 of wall 52 for engaging the side edges 80 and 82 of flat cable 18 as flat cable 18 moves within cable cavity 22. Similarly, when first layer 24 is placed on the bearing surface 50 of stationary member 14, first surface 24 rests on bearing surface 50 and second layer 26 extends to wall 52 of moveable member 16 with extended portion 28 providing a smooth transition.

The thick first layer 24 of sound dampener 20 fills any gaps between the flat cable side edges 80 and 82 and the bearing surfaces 50 and 64 of stationary and moveable members 14 and 16, respectively, thereby leaving substantially no space between bearing surfaces 50 and 64 and flat cable 18, as seen in FIGS. 3 and 4. By eliminating all of the space between flat cable 18 and bearing surfaces 50 and 64, the impact of the flat cable side edges 80 and 82 against the bearing surfaces 50 and 64 during vibration of the clockspring 10 is reduced, thereby significantly reducing noise due to such impact from vibration of clockspring 10.

Sound dampener 20 adjusts to variability in sizes of the components of clockspring 10, such as the stationary and moveable members 14 and 16. Size variability often occurs due to the molding of the components. In particular, since the first layer 24 of sound dampener 20 is made of a resilient material, such as foam, sound dampener 20 can be compressed to accommodate the variability in sizes of the molded components. There is a very slight interference fit between the edges of flat cable 18 and dampener 20 leaving no space therebetween but allowing flat cable 18 to move as it winds and unwinds within the clockspring.

The second layer 26 of the sound dampener 20 reduces the friction between flat cable side edges 80 and 82 rubbing against bearing surfaces 50 and 64 as flat cable 18 is wound and unwound within cable cavity 22 by providing smooth engagement surface 100, thereby significantly reducing the frictional noise. Extended portion 28 ensures that smooth engagement surface 100 extends to wall 52 of moveable member 16. Otherwise, side edges 80 and 82 of flat cable 18 may rub against exposed areas of bearing surfaces 50 and 64, such as ledge 68 of bearing surface 64 creating unwanted frictional noise. The combination of the first and second layers 24 and 26 of sound dampener 20 significantly reduce both vibrational noise and frictional noise.

Referring to FIG. 7, a sound dampener 220 in accordance with a second embodiment of the present invention is the same as sound dampener 20 of the first embodiment, except that ring body 286 of dampener 220 is not continuous like ring body 86 of dampener 20. The same reference numerals that describe sound dampener 20 of the first embodiment apply to like elements of the sound dampener 220 of the second embodiment. Ring body 286 of sound dampener 220 includes a cutout section 287 formed in both layers 24 and 26 of dampener 20. Cutout section 287 is contiguous with the first and second apertures 92 and 96 of first and second layers 24 and 26.

Sound dampener 220 is used with clockspring 10 in the same manner as sound dampener 20. Cutout section 287 can be aligned with either connector unit 42 and 74 of stationary and moveable members 14 and 16, respectively, to accommodate flat cable 18 at the connection area of either connector unit 42 and 74.

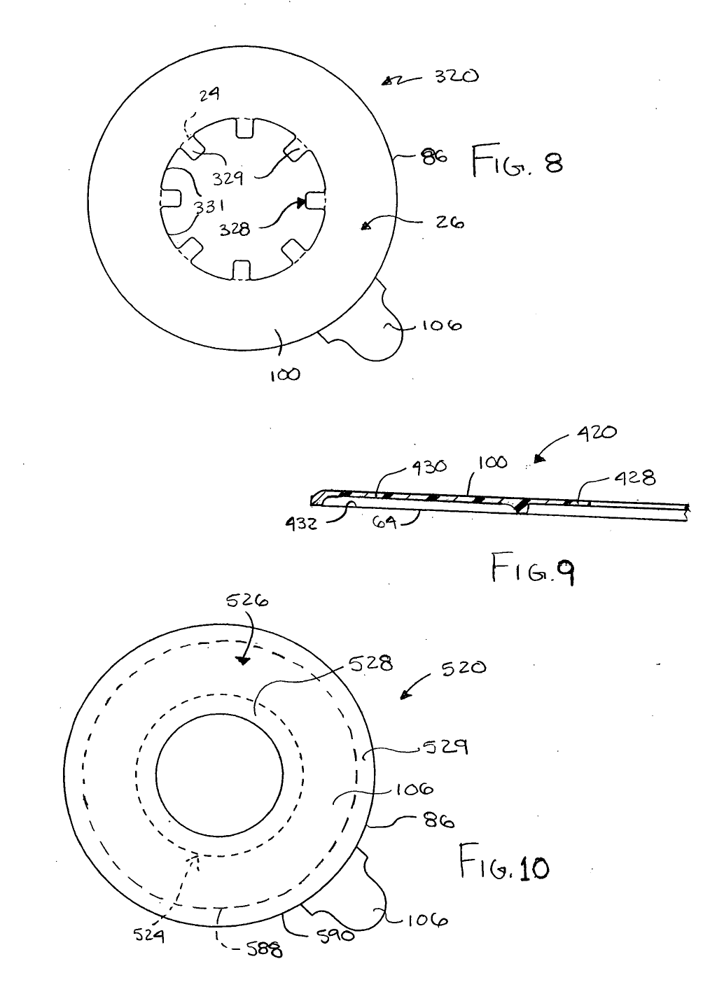

Referring to FIG. 8, a sound dampener 320 in accordance with the third embodiment of the present invention is the same as sound dampener 20 of the first embodiment, except extended portion 328 of dampener 320, similar to extended portion 28 of dampener 20, includes fingers 329. The same reference numerals that describe sound dampener 20 of the first embodiment apply to like elements of the sound dampener 320 of the third embodiment. More specifically, fingers 329 are defined by cutouts 331 in extended portion 328 of second layer 26. Fingers 329 of sound dampener 320 can be longer that extended portion 28 of sound dampener 20 of the first embodiment such that fingers 329 engage and extend along outer surface 58 of wall 52 of moveable member 16. For example, if sound dampener 320 is disposed on bearing surface 64 of moveable member 16, fingers 329 would extend along wall 52 toward bearing surface 50 of stationary member 14.

Sound dampener 320 is used with clockspring 10 in the same manner as sound dampener 20. Fingers 329 extend smooth engagement surface 100 to along outer surface 58 of wall 52 of moveable member 14.

Referring to FIG. 9, a sound dampener 420 in accordance with a fourth embodiment of the present invention is the same as sound dampener 20 of the first embodiment, except first and second layers 24 and 26 are formed as a one-piece member 426. The same reference numerals that describe sound dampener 20 of the first embodiment apply to like elements of the sound dampener 420 of the fourth embodiment. Preferably, one-piece member 426 is made of any soft moldable plastic, such as a polyester elastomer. Member 426 includes smooth engagement surface 100 for engaging flat cable side edges 80 and 82 and fills the gaps between flat cable 18 and bearing surfaces 50 and 64 of stationary and moveable members 14 and 16. Member 426 also includes an extended portion 428 similar to extended portion 28 of sound dampener 20 of the first embodiment. Member 426 includes a flexible and elastic thin area 430 defining a pocket 432 between member 426 and either bearing surface 50 or 64 (FIG. 9 shows bearing surface 64).

Sound dampener 420 is used in generally the same manner as sound dampener 20 of the first embodiment. Flexible area 430 can move in and out of pocket 432 to adjust to the flat cable 18 and the variability of the component sizes. The flat cable 18 and engagement surface 100 of dampener 420 engage with a slight interference fit.

Referring to FIG. 10, a sound dampener 520 in accordance with a fifth embodiment of the present invention is the same as sound damper 20 of the first embodiment, except in addition to an extended portion 528 of second layer 526 like extended portion 28 of layer 26 of dampener 20, second layer 526 has a second extended portion 529 along its outer periphery. The same reference numerals that describe sound dampener 20 of the first embodiment apply to like elements of the sound dampener 520 of the fifth embodiment. The outer perimeter 588 of the first layer 524 of sound dampener 520 defines a circumference that is less than the circumference of the outer perimeter 590 of second layer 526, thereby defining second extend portion 529. Sound dampener 520 is used with clockspring 10 in the same manner as sound dampener 20.

While particular embodiments have been chosen to illustrate the invention, it will be understood by those skilled in the art that various changes and modification can be made therein without departing from the scope of the invention as defined in the appended claims.

1. A sound dampener, comprising:
a first layer having first and second opposite surfaces, said first layer being substantially ring-shaped defining a first central aperture with a first perimeter; and
a second layer disposed on one of said first and second opposite surfaces of said first layer, said second layer being substantially ring-shaped defining a second central aperture with a second perimeter, and said second perimeter defining a circumference that is smaller than a circumference of said first perimeter of said first central aperture so that an extended portion of said second layer extends beyond said first perimeter of said first central aperture of said first layer.

2. A sound dampener according to claim 1, wherein
said first layer and said second layer are disposed in a clockspring.

3. A sound dampener according to claim 1, wherein
said second layer is laminated to said one of said first and second surfaces of said first layer.

4. A sound dampener according to claim 1, wherein
an adhesive layer is disposed on the other of said one of said first and second surfaces of said first layer; and
a release liner is disposed on said adhesive layer.

5. A sound dampener according to claim 1, wherein
said first layer is made of a resilient material; and
said second layer is made of a smooth plastic material.

6. A sound dampener according to claim 5, wherein
said first layer is formed of a material selected from the group consisting of microporous plastic, polystyrene, open cell foam, and closed cell foam.

7. A sound dampener according to claim 5, wherein
said second smooth layer is formed of a material selected from the group consisting of polyethylene, synthetic thermoplastic resin, and polyester.

8. A sound dampener according to claim 1, wherein
said first layer is substantially thicker than said second layer.

9. A sound dampener according to claim 1, wherein
said first and second layers form a continuous ring.

10. A sound dampener according to claim 1, wherein
a cutout section is formed in each of said first and second layers that is contiguous with said first and second central apertures.

11. A sound dampener according to claim 1, wherein
said extended portion includes cutouts defining fingers.

12. A sound dampener according to claim 1, wherein
said first and second layers are formed as a one-piece member.

13. A sound dampener according to claim 12, wherein
said one-piece member includes a thin flexible area defining a pocket.

14. A sound dampener according to claim 1, wherein
said second layer includes a second extended portion extending beyond an outer perimeter of said first layer.

15. A clockspring, comprising:
a stationary member having a first bearing surface;
a movable member rotatably engaged with said stationary member, said movable member having a second bearing surface;
a cable retaining compartment defined between said stationary and movable members;
a flat cable disposed in said cable retaining compartment, and having opposite first and second ends and opposite first and second side edges; and
a sound dampener disposed between either one of said first bearing surface of said stationary member and said first side edge of said flat cable and said second bearing surface of said movable member and said second side edge of said flat cable so that there is substantially no space between said first bearing surface and said first side edge and between said second bearing surface and said second side edge, and said sound dampener having a first resilient layer with a second smooth layer being disposed on said first resilient layer.

16. A clockspring according to claim 15, wherein
said first resilient layer is substantially ring-shaped and defines a first central aperture with a first perimeter; and
said second smooth layer is substantially ring-shaped and defines a second central aperture with a second perimeter, and said second perimeter defining a circumference that is smaller than a circumference of said first perimeter of said first central aperture so that an extended portion of said second smooth layer extends beyond said first perimeter of said first central aperture of said first resilient layer.

17. A clockspring according to claim 16, wherein
said extended portion includes cutouts defining fingers.

18. A clockspring according to claim 16, wherein
said second smooth layer includes a second extended portion extending beyond an outer perimeter of said first resilient layer.

19. A clockspring according to claim 15, wherein
said first resilient layer is substantially thicker than said second smooth layer.

20. A clockspring according to claim 15, wherein
said first resilient layer and said second smooth layer form a continuous ring.

21. A clockspring according to claim 15, wherein
a cutout section is formed in each of said first resilient layer and said second smooth layer that is contiguous with said first and second central apertures.

22. A clockspring according to claim 15, wherein
said first resilient layer and second smooth layer are formed as a one-piece member.

23. A clockspring according to claim 15, wherein
said sound dampener adjusts to different sizes of the stationary and moveable members.

24. A clockspring, comprising:
a stationary member having a first bearing surface;
a movable member rotatably engaged with said stationary member, said movable member having a second bearing surface;
a cable retaining compartment defined between said stationary and movable members;
a flat cable disposed in said cable retaining compartment, and having opposite first and second ends and opposite first and second side edges; and
a sound dampener disposed between either one of said first bearing surface of said stationary member and said first side edge of said flat cable and said second bearing surface of said movable member and said second side edge of said flat cable, and said sound dampener having a first layer with a first central aperture defining a perimeter with a second layer being disposed on said first layer and including an extended portion extending beyond said perimeter of said first layer.

25. A clockspring according to claim 24, wherein
said first layer is made of a resilient material; and
said second layer is made of a smooth material.

26. A clockspring according to claim 24, wherein
said movable member includes a central hub; and
said extended portion extends towards said central hub.

27. A clockspring according to claim 24, wherein
said first layer is substantially thicker than said second layer.

28. A clockspring according to claim 24, wherein
substantially no space exists between said first bearing surface and said first side edge of said flat cable and between said second bearing surface and said second side edge of said flat cable.

29. A clockspring according to claim 24, wherein
said first and second layers form a one-piece member.

30. A clockspring according to claim 29, wherein
said one-piece member includes a thin flexible area defining a pocket between said sound dampener and said one of said first and second bearing surfaces.
